(19) United States
(12) Patent Application Publication
(10) Pub. No.: US 2026/0113068 A1
(43) Pub. Date: Apr. 23, 2026

(54) TRANSCEIVER INTERFACE AND TRANSCEIVER SYSTEM

(71) Applicant: FLEXOPTIX GMBH, Darmstadt (DE)

(72) Inventors: David Elias ÖNAL, Darmstadt (DE); Thomas WEIBLE, Darmstadt (DE); Markus ARNOLD, Darmstadt (DE)

(73) Assignee: FLEXOPTIX GMBH, Darmstadt (DE)

(21) Appl. No.: 19/476,122

(22) PCT Filed: Mar. 19, 2024
(86) PCT No.: PCT/EP2024/057246

§ 371 Date: Oct. 16, 2025

(30) Foreign Application Priority Data
Apr. 17, 2023 (DE) 10 2023 109 616.8

(51) Int. Cl. H04B 1/3888; G06F 1/16; G06F 13/38; H02J 50/10

(52) U.S. Cl. CPC H04B 1/3888; G06F 1/1632; G06F 13/382; H02J 50/10

(57) ABSTRACT

The invention relates to a transceiver interface, in particular a mobile transceiver interface, having at least one transceiver slot which is provided for connecting a plug-in transceiver, and having a housing unit which has a receiving space for receiving at least a major part of the transceiver in a plugged-in state of the transceiver in the transceiver slot. In order to provide a generic device with improved properties with regard to construction, it is proposed that the housing unit has at least one further receiving space for receiving at least a major part of a further transceiver, which receiving space at least partially intersects with the receiving space.

### PRIOR ART

The invention relates to a transceiver interface according to the preamble of Claim 1 and to a transceiver system according to Claim 14.

A transceiver interface for programming a transceiver is already known from the prior art, for example from document DE 10 2016 115 546 A1.

The object of the invention is in particular to provide a generic device which has improved properties with regard to its design. This object is achieved according to the invention by the features of Claims 1 and 14, while advantageous embodiments and further developments of the invention can be obtained from the subclaims.

### ADVANTAGES OF THE INVENTION

The invention is based on a transceiver interface, in particular a mobile transceiver interface, having at least one transceiver slot which is designed for connecting a pluggable transceiver, and having a housing unit which has a receiving space for receiving at least a major part of the transceiver in a plugged-in state of the transceiver in the transceiver slot.

It is proposed that the housing unit, in order to receive at least a major part of a further transceiver, has a further receiving space which at least partially intersects with the receiving space.

Such a design can improve the construction of a transceiver interface. Moreover, a very compact transceiver interface can be provided, which in turn allows storage and transport of the transceiver interface to be significantly optimised. Furthermore, this can increase handling ability, user-friendliness and user convenience. In addition, a high level of security and improved stability of a connection to a transceiver can be provided. In particular, by means of the transceiver interface, specifically a housing unit of the transceiver interface, mounting and storage of at least a major part of the transceiver can be provided. Furthermore, efficiency, advantageously with regard to performance efficiency, and/or product efficiency can be improved.

The transceiver interface is in particular an electrical and/or electronic and preferably mobile device, which is designed for the configuration and/or reconfiguration of at least the transceiver. The configuration should be advantageously understood here to mean programming, in particular reprogramming, of the transceiver, preferably an encoding and/or an identifier of the transceiver. Alternatively and/or additionally, the configuration of the transceiver, in particular by means of a configuration unit, could comprise performing a tuning and/or a test operation, in particular a tuning and/or a test of the transceiver, and/or performing a measurement, in particular for measuring and/or calibrating the transceiver, and/or measuring and/or calibrating a further object by means of the transceiver. The tuning could be, in particular, a wavelength tuning. In a method for operating the transceiver interface, the transceiver can be configured, in particular programmed and/or tuned and/or tested. Preferably, the transceiver interface is implemented as a mobile device, in particular as a handheld. Alternatively, the transceiver interface could also be designed as a stationary device.

Advantageously, the transceiver interface has a configuration unit for the purpose of configuration, in particular the encoding and/or the identification, of the transceiver. The configuration unit could modify, recode, reprogram and/or adapt the configuration of the transceiver, in particular to different hardware types and/or hardware configurations, to advantageously enable the use of the transceiver with different hardware, such as from different hardware manufacturers. Preferably, the transceiver is configured to allow the use of the transceiver with different PSEs, in particular from different hardware manufacturers. Preferably, the configuration unit is designed for changing the configuration of the transceiver multiple times and/or repeatedly.

The transceiver interface can be part of a transceiver system. The transceiver system, in particular an optical transceiver system, is advantageously designed for configuring and/or reconfiguring at least the transceiver. The transceiver system can be designed for carrying out a test operation, in particular for testing the transceiver, and/or for carrying out a measurement operation, in particular for measuring and/or calibrating the transceiver and/or for measuring and/or calibrating another object by means of the transceiver. In particular, at least the transceiver is part of the transceiver system. The transceiver system could be, for example, an SFP, in particular an SFP-DD, SFP+, SFP28 and/or CSFP, and/or a CFP, in particular, a CFP2, CFP4 and/or CFP8, and/or a QSFP, in particular a QSFP+, QSFP14, QSFP28, QSFP56, and/or QSFP-DD, and/or an XFP and/or OSFP and/or NGSFP, in particular an NGSFP-DD and/or OSFP-XD transceiver system or the like. The transceiver system could be at least one data transmission system and/or a communication system comprising the transceiver interface and at least the transceiver. Preferably, the transceiver interface has at least one storage unit for storing at least operating parameters and/or configuration settings.

Preferably, the transceiver system has at least one serial interface for providing a serial connection between the transceiver interface and a data transmission unit. This allows a particularly flexible, efficient and convenient transceiver system to be provided. In addition, a high degree of versatility of connectivity between the t transceiver interface and other data transmission units can be provided.

For example, the serial interface can be an RJ45 or an RS232 interface. The data transmission unit distinct from a transceiver, for example, may be an RJ plug, in particular an RJ45 plug, an RS232 plug, an Ethernet plug or another type of telephone and/or Internet plug. The transceiver interface may comprise the serial interface. It would be conceivable that the transceiver interface has at least one slot for providing the serial interface. The slot can be an RJ45 or an RS232 slot, for example. It is thus possible to dispense with an additional adapter.

Particularly preferably, the transceiver system comprises at least one adapter for connecting to the transceiver interface and for providing a serial connection between the transceiver interface and the data transmission unit. The adapter is advantageously an accessory and/or retrofit part of the transceiver system for the transceiver interface. The adapter is preferably mobile, in particular portable. In particular, the adapter is provided for communication with at least the transceiver interface. The adapter can be reversibly plugged into at least the transceiver slot. It is conceivable that the data transmission unit is a transceiver, wherein the transceiver and the transceiver slot are of different types, for example, the transceiver is an XFP transceiver and the transceiver slot is an SFP transceiver slot, so that the adapter preferably allows communication and/or connection between the transceiver and the transceiver slot of a different type. Advantageously, the adapter allows a communication and/or connection between a data transmission unit distinct from a transceiver to the transceiver interface. Particularly preferably, the adapter is designed to provide a serial connection from an SFP transceiver slot to an RJ-45 port or an RS232 port, which in particular allows network switches to be configured.

The transceiver interface may potentially be a stationary device. Preferably, the transceiver interface is implemented as a mobile device, in particular as a handheld and/or a hand-held unit. Preferably, the transceiver interface forms an interface between an external unit and the transceiver. The external unit is in particular an electronic external device, preferably designed as an operating unit and/or control unit, which is designed in particular for operating and/or controlling the transceiver interface, and preferably for configuring the transceiver. The external unit can be a terminal device, advantageously a mobile device. The external unit could be, for example, a computer, in particular a permanently installed one, and/or a laptop and/or a convertible and/or a mobile phone, in particular smartphone, and/or a tablet and/or a phablet and/or a personal digital assistant (PDA) and/or an equivalent electronic device and/or a special application for controlling the transceiver interface and/or for configuring the transceiver. The operation and/or control of the transceiver interface and/or the configuration of the transceiver may possibly take place directly by means of a browser, in particular one that is executable on the external device. Preferably, the external unit is part of the transceiver system. The transceiver interface may comprise a communication interface, in particular a wire-bound and/or wireless communication interface, for communication with the external unit.

With regard to further descriptions of embodiments and a functioning of the external unit as well as an interaction of the external unit with the transceiver interface, in particular a configuration and function of the communication interface of the transceiver interface, reference is made to the German patent applications DE 10 2021 119 318 A1 with the filing number 10 2021 119 318.4 and to DE 10 2021 119 316 A1 with the filing number 10 2021 119 316.8, the content of which is incorporated into this application. In addition, with regard to the design and functioning of the aforementioned configuration unit, reference is also made to the German patent applications DE 10 2021 119 318 A1 and DE 10 2021 119 316 A1 just mentioned.

The transceiver can be an electrical, in particular an electrical-electrical, transceiver or preferably an optical, in particular an optical-electrical, transceiver (OT). If an optical transceiver is used, the transceiver is preferably designed to provide an optical-electrical receiving device and an electrical-optical transmitting device. The optical transceiver could receive at least optical signals from at least one data transmission unit, in particular a fibre, such as an optical fibre, and/or convert the optical signals at least into electrical signals. The transceiver is a plug-in transceiver, in particular a pluggable transceiver. The transceiver could be, for example, an SFP, in particular an SFP-DD, SFP+, SFP28 and/or CSFP, a CFP, in particular a CFP2, CFP4 or CFP8, a QSFP, in particular a QSFP+, QSFP14, QSFP28, OSFP56 or QSFP-DD, an OSFP, NGSFP, in particular an NGSFP-DD or OSFP-XD or an XFP transceiver. The transceiver could be designed for arrangement, in particular for connection to, and/or for communication with a power sourcing equipment (PSE) device, wherein the PSE could be, for example, a router and/or a hub and/or advantageously a switch.

The transceiver could be connectable to the transceiver interface in a reversible, in particular releasable, and preferably non-destructively releasable manner, and preferably able to be plugged into the transceiver interface, namely the transceiver slot. In particular, the transceiver slot enables wired communication with the transceiver. The transceiver interface is advantageously an electrical and/or electronic interface, in particular connection interface, which is designed for, in particular electrical, connection to the transceiver. In the plugged-in state, the transceiver can communicate with the configuration unit by means of the transceiver slot. In a method for operating the transceiver interface, the transceiver can be plugged into the transceiver slot. The transceiver slot advantageously at least partially receives the transceiver in at least one connected state, namely the plugged-in state. In an unconnected state, at least the transceiver is arranged separately from the transceiver interface.

The transceiver slot may have at least one contact element, advantageously a standardized transceiver contact element, in particular transceiver plug connector element and advantageously built-in plug connector element, which is provided for, in particular electrical, contacting with the transceiver. In this context, standardized object is intended advantageously to be an object which has at least partially standardized dimensions, in particular external dimensions, and/or an at least partially standardized shape and/or standardized construction components and/or is designed to provide standardized data transmission rates. The transceiver slot could provide communication with the transceiver at data transmission rates of at least 10 Gbit/s, in particular at least 50 Gbit/s, advantageously at least 100 Gbit/s, in particular at least 200 Gbit/s, preferably at least 400 Gbit/s, preferably 800 Gbit/s and particularly preferably at least 1600 Gbit/s.

In particular, the housing unit is designed for mounting and/or holding at least a major part of the transceiver in the plugged-in state. Alternatively, it would also be conceivable that in the plugged-in state the transceiver is arranged, at least in some sections or completely, contact-free with respect to the housing unit. Advantageously, the receiving space is designed for receiving at least a major part of a longitudinal extent of the transceiver in the plugged-in state. Preferably, the receiving space in the plugged-in state of the transceiver receives at least 40%, advantageously at least 60%, preferably at least 70% and particularly preferably at least 85% of the longitudinal extension of the transceiver. It would also be conceivable for the entire transceiver, in particular the entire longitudinal extension of the transceiver, to be arranged in the receiving space in the plugged-in state. In the plugged-in state of the transceiver, a maximum of 30%, preferably a maximum of 20% and preferably a maximum of 10% of the longitudinal extension of the transceiver could be arranged outside the receiving region. The transceiver could at least partially protrude from the housing unit in the plugged-in state. Preferably, the transceiver, in particular the longitudinal extension of the transceiver, protrudes in the plugged-in state to a maximum of 40%, advantageously to a maximum of 20% and preferably to a maximum of 10%, out of the housing unit. In this context, a “longitudinal extension” of an object is to be understood as an extension of the object in a longitudinal extension direction of the object. The “longitudinal extension direction” of the object is a direction which is oriented and/or extends parallel to a longest edge and/or side of an, in particular imaginary, smallest cuboid that just encloses the object. The term “to a large extent” shall be understood to mean at least 55%, advantageously at least 65%, preferably at least 75%, particularly preferably at least 85% and particularly advantageously not more than 95% of a surface area and/or volume proportion.

Particularly preferably, the housing unit is designed to accommodate at least a major part of the weight of the transceiver in the plugged-in state. The housing unit in the plugged-in state of the transceiver can accommodate and/or hold and/or carry at least 40%, advantageously at least 50% and preferably at least 80% of the weight of the transceiver.

The housing unit may be designed for supporting and/or resting the transceiver in the plugged-in state. The housing unit may have at least one contact surface in the receiving space for at least partially resting the transceiver in the plugged-in state.

The housing unit can have an outer housing. Preferably, the housing unit comprises an inner housing. The outer housing can enclose the inner housing on at least two, preferably on at least three and preferably on at least five sides. In particular, the receiving space is at least partially bounded by the outer housing and/or the inner housing. Advantageously, the receiving space is bounded by at least one housing wall of the housing unit. The receiving space may be bounded by at least two, advantageously by at least three and preferably by at least five sides. At least one housing ceiling wall of the housing unit and/or a housing bottom wall of the housing unit can bound the receiving space. The housing wall can be part of the outer housing or the inner housing. The outer housing may comprise at least one first outer housing element and at least one second outer housing element. Preferably, the outer housing element is designed as a housing cover. The second outer housing element can be designed as a housing bottom. The inner housing may be arranged between the first outer housing element and the second outer housing element in an assembled state of the housing unit. The inner housing may be arranged above and/or on the first outer housing element and/or the second outer housing element. In particular, the inner housing is arranged, in a plan view of a main extension plane of the housing unit, above the second outer housing element. The receiving space may extend at least partially or completely within the inner housing.

The transceiver interface can have a plurality, in particular at least two and/or at least three, transceiver slots, which are designed in particular for the optional connection of at least the transceiver and advantageously at least the further transceiver. It might be conceivable that the transceiver and at least the further transceiver are simultaneously in the plugged-in state and at least partially received by the housing unit. Particularly preferably, the housing unit can receive only one transceiver, preferably exactly one transceiver, namely the transceiver or the further transceiver, in the plugged-in state. In particular, if a transceiver is in the plugged-in state and the housing unit receives the transceiver, no further transceiver can be plugged in and received by the housing unit.

An extension, in particular a longitudinal, transverse and/or height extension, of the receiving space and a further extension, in particular a further longitudinal, transverse and/or height extension, of the further receiving space could intersect by at least 20%, advantageously by at least 40% and preferably by at least 60%. Preferably, the receiving space and the further receiving space intersect, at least in some sections within the inner housing of the housing unit. In particular, the receiving space and the further receiving space intersect by at least 30%, advantageously by at least 50% and preferably by at least 80%.

The transceiver is preferably a transceiver of a first type. For example, the transceiver may be designed as an OSFP transceiver. The further transceiver can be a transceiver of a second type. For example, the further transceiver may be designed as a QSFP-DD transceiver. The transceiver slot could be designed for connecting a transceiver of the first type and a transceiver of at least the second type. Preferably, the transceiver slot is designed for receiving only transceivers of one type, in particular transceivers of the first type.

The term “designed” is to be understood here and in the following to mean specifically programmed, configured and/or equipped. The fact that an object is designed for a specific function, is intended to mean that the object fulfils and/or performs this specific function in at least one application state and/or operating state.

It is further proposed that an insertion opening of the transceiver slot faces the receiving space. This can further optimize the design and reduce or prevent contamination and/or destruction of a transceiver slot. In addition, protection of the transceiver slot from external influences such as contaminants and/or temperature fluctuations can be improved, thus in turn increasing the service life of the transceiver slot. In addition, a secure and efficient connection of a transceiver to the transceiver slot can be provided.

The transceiver interface may have at least one printed circuit board. At least the transceiver slot can be arranged on the printed circuit board. The printed circuit board may be connected to the first and/or second outer housing element. Advantageously, the printed circuit board is connected in a force-fitting, positive-fitting and/or materially bonded manner to at least the second outer housing element and, in particular, arranged on at least the second outer housing element by means of a force-fitting, positive-fitting and/or materially bonded connection. The inner housing is preferably arranged over and/or on the printed circuit board. The printed circuit board can at least partially bound the receiving space. In particular, the printed circuit board and at least the inner housing together at least partially or completely bound the receiving space. Preferably, the inner housing and at least the printed circuit board at least partially or completely bound the further receiving space. The inner housing can surround and/or encircle the transceiver slot, at least in sections. Preferably, at least the transceiver slot bounds the receiving space, at least on one side. The insertion opening may be surrounded by the inner housing at least on two or at least on three sides. This advantageously ensures a high level of protection of an insertion opening of a transceiver slot, for example, against environmental influences. In particular, in the plugged-in state the transceiver is arranged in the insertion opening of the transceiver slot.

It is also proposed that the housing unit has at least one feed-through opening for feeding the transceiver through to the transceiver slot, which opening is arranged at an opposite end of the housing unit to the insertion opening of the transceiver slot. Thus, a preferably large receiving space for receiving a transceiver in a plugged-in state can be provided, so that the retention of the transceiver in the plugged-in state can be improved. In addition, a design of a transceiver interface can in turn be optimized and the handling for a user can be made simpler and more comfortable.

In particular, the feed-through opening is arranged at an opposite end of the housing unit to the insertion opening of the transceiver slot. Advantageously, the feed-through opening and the insertion opening are located at opposite ends of the housing unit. Preferably, the insertion opening and the feed-through opening are aligned with each other. An object and/or a direction which is/are at least partially aligned with a further object and/or a further direction, deviates/deviate by less than 10%, preferably less than 5% and particularly preferably less than 2% from an orientation of the further direction and/or arrangement and/or orientation of the further object. The inner housing and/or the outer housing, in particular the first outer housing element and/or the second outer housing element, can at least partially comprise or form the feed-through opening or bound the feed-through opening at least to one side. Advantageously, the first outer housing element at least partially comprises the feed-through opening or bounds the feed-through opening at least to one side, preferably at least to three and particularly preferably at least to four sides. The inner housing can bound the feed-through opening at least to one side, advantageously at least to two sides. The receiving space may extend at least between the feed-through opening and the insertion opening of the transceiver slot. The receiving space could also extend outside, in a surrounding region of the feed-through opening, and in particular be bounded by at least the second outer housing element. A user can insert the transceiver into the transceiver slot through the feed-through opening. It would be conceivable for the transceiver interface, in particular the housing unit, to have yet more feed-through openings for feeding through at least the transceiver.

In another aspect of the invention, which can be considered in particular as both stand-alone and in combination with the other aspects of the invention, it is proposed that the transceiver interface has at least one further transceiver slot, which is designed for connecting a further transceiver, in particular the already mentioned further transceiver, and which in a plugged-in state of the transceiver in the transceiver slot is blocked for connecting the further transceiver. Such a design can provide a particularly compact, efficient and convenient design. It also enables an intuitive and user-friendly application and further increases efficiency.

In particular, the further transceiver slot is provided for receiving at least the further transceiver. The further transceiver slot could be designed for connecting a transceiver of the first type and a transceiver of at least the second type. Preferably, the transceiver slot is designed for receiving only transceivers of one type, in particular transceivers of the second type.

In addition, the descriptions and explanations regarding an arrangement of the transceiver slot can also be transferred to the further transceiver slot. The further transceiver slot can bound the further receiving space to at least one side. Preferably, the further receiving space extends from at least the further transceiver slot. Advantageously, the descriptions and explanations already given for the receiving space are also transferable to the further receiving space,, in particular taking into account the reference to the further transceiver slot.

In particular, a connection of the further transceiver in the further transceiver slot is blocked in the plugged-in state of the transceiver in the transceiver slot. The transceiver inserted in the transceiver slot can block the connection of the further transceiver into the further transceiver slot. In addition, the further transceiver inserted into the further transceiver slot can block a connection of the transceiver to the transceiver slot. Preferably, the further transceiver inserted into the further transceiver slot blocks the connection of the transceiver to the transceiver slot in the plugged-in state.

If a plug-in direction of the transceiver slot and a further plug-in direction of the further transceiver slot enclose an angle of at least 100°, the design can be further increased with regard to compactness and/or handling ability. In addition, an arrangement and/or mounting of a transceiver in a transceiver interface can be further improved, and stability when providing a connection can be increased.

In particular, the plug-in direction of the transceiver slot and the additional plug-in direction of the further transceiver slot enclose an angle of at least 120° and advantageously at least 130°. In addition, the plug-in direction of the transceiver slot and the additional plug-in direction of the further transceiver slot can enclose an angle of at most 170°, advantageously at most 160° and preferably at most 140°.

In a further aspect of the invention, which can be considered in particular as both stand-alone and in combination with the other aspects of the invention, it is proposed that the transceiver interface has at least one sensor unit for sensing at least one temperature characteristic of at least the transceiver in a plugged-in state. Such a design can increase efficiency with regard to product efficiency, and further optimize the design. In addition, temperature monitoring can be provided during operation of a transceiver interface, thus increasing safety and convenience for a user.

The sensor unit can be arranged on the printed circuit board and/or the housing unit. Preferably, the sensor unit is arranged on the transceiver slot and/or at least the further transceiver slot. The sensor unit may be designed at least partially as a single piece, in particular as a single part, with the printed circuit board, the housing unit and/or the transceiver slot. In particular, in the operating state of the transceiver interface, at least in the plugged-in state of the transceiver in the transceiver slot and/or at least in the plugged-in state of the further transceiver in the further transceiver slot, the sensor unit senses at least the temperature characteristic at least of the transceiver and/or the further transceiver. If the transceiver is plugged into the transceiver slot, the sensor unit can sense and/or detect the temperature characteristic. A “temperature characteristic” as used here is a characteristic parameter associated with at least a temperature, which can be, for example, the temperature itself, a time-dependent temperature profile and/or a temperature difference. Furthermore, the temperature characteristic could be an electrical voltage and/or an electrical current strength, which is correlated with a temperature, a time-dependent temperature profile and/or a temperature difference. Preferably, based on the sensed and/or detected temperature characteristic, an existing temperature, in particular an actual temperature, can be determined in the operation of the transceiver interface, preferably during configuration and/or reconfiguration of the transceiver.

Furthermore, a “sensor unit” in this context shall be understood to mean a unit which is designed to record at least one characteristic and/or physical property, wherein the recording can take place actively, in particular by generating and emitting an electrical measurement signal, and/or passively, such as in particular by detecting changes in a property of a sensor component. The sensor unit can comprise, for example, at least one thermistor, a PTC thermistor, a platinum measuring resistor, a semiconductor temperature sensor, a fibre-optic temperature sensor, a thermocouple and/or a ferromagnetic temperature sensor. Various sensor units that appear reasonable to a person skilled in the art are conceivable. The transceiver interface may comprise additional sensor units, namely at least one additional sensor unit or at least two additional sensor units. The additional sensor unit is preferably arranged on the further transceiver slot for sensing at least one further temperature characteristic of at least the further transceiver in the plugged-in state. The additional sensor unit may be designed at least partially as a single piece, in particular as a single part, with the printed circuit board, the housing unit and/or the further transceiver slot. If the further transceiver is plugged into the further transceiver slot, the additional sensor unit can sense and/or detect the additional temperature characteristic.

If the sensed and/or detected temperature characteristic exceeds an in particular predefined limit value, the transceiver interface can output, for example by means of an acoustic and/or optical output unit, at least one signal, preferably a warning, to the user. The limit value may be a limit-value temperature, which, for example, can be at most 200° C., advantageously at most 90° C., preferably at most 70° C., and particularly preferably at most 65° C.

In a further aspect of the invention, which can be considered in particular as both stand-alone and in combination with the other aspects of the invention, it is proposed that the transceiver interface has at least one fixing unit for the force-fitting and/or positive-locking fixing of an external mobile device to the housing unit. By means of such a configuration, a construction can be improved and a secure and/or stable mounting and/or fixation of an external mobile device to a transceiver interface can be achieved. In addition, a particularly flexible and/or mobile transceiver interface can be provided while increasing user comfort and/or handling ability. In addition, this can prevent the external mobile device from falling off and/or detaching from the transceiver interface, in particular during an operating state.

In particular, the fixing unit has at least one fixing element, which is designed for at least partially holding and/or securing the external mobile device and preferably to at least partially and advantageously completely restrict or prevent any movement of the external mobile device in at least one spatial direction and advantageously in at least two spatial directions. The force-fitting and/or positive-locking fixing may be a force-fitting and/or positive-locking connection, such as a snap-in connection and/or plug connection and/or rotary connection and/or screw connection and/or clamping connection and/or Velcro connection. Preferably, the external mobile device is the external unit mentioned above.

It would also be conceivable that the fixing unit is designed for a materially bonded fixing, such as for providing an adhesive bond. Preferably, the fixing unit is designed for a reversible, in fact releasable, connection of the external mobile device to the housing unit. In particular, the external mobile device can be placed on top of the housing unit for fixing. The fixing unit could have at least one adhesive friction element, which is designed for increasing adhesive friction, in particular in the region of a contact surface with the external mobile device. The adhesive friction element can be formed as any adhesive friction element, such as, for example, a rough and/or roughened surface element, as a silicone element and/or advantageously as a rubber element, in particular as a rubber mat and/or a rubber coating.

In order to provide a particularly convenient, user-friendly, easy and manageable fixing of an external mobile device to a transceiver interface, it is proposed that the fixing unit has at least one magnetic element for providing a magnetic fixing. In addition, complex and/or space-consuming fixings can be dispensed with.

The magnetic element can enter into a magnetic connection with a counter-magnetic element of the external mobile device to secure the external mobile device to the housing unit. The fixing unit could comprise exactly one magnetic element. It would be conceivable that the magnetic element has a round or oval shape and/or is formed as a circular disc or ring. Advantageously, the fixing unit has at least two, preferably at least three or more magnetic elements, which can be designed in particular identical to each other. The magnetic elements could be arranged, for example, next to one another. Preferably, at least three magnetic elements are arranged opposite one another in the shape of a triangle. The external mobile device could be able to be placed at least partially, and preferably completely, on top of the housing unit. In the method for operating the transceiver interface, the external mobile device can be placed at least partially on the housing unit. With the external mobile device arranged on the housing unit, at least 10%, advantageously at least 30%, preferably at least 50% and particularly preferably at least 80% of a main extension of the external mobile device could rest on top of the housing unit. The fixing unit is advantageously designed at least substantially flat. In particular, the fixing unit has a main extension plane that is at least substantially parallel to a main extension plane of the housing unit, wherein an orientation of a plane, in particular the main extension plane of the fixing unit, deviates by a maximum of 8°, advantageously by a maximum of 5° and particularly advantageously by a maximum of 1° from an orientation of a reference plane, in particular the main extension plane of the housing unit. Advantageously, the fixing unit is at least partially and preferably completely surrounded and/or covered by the outer housing. The fixing unit may be arranged on the inner housing of the housing unit and/or connected to the inner housing. It would also be conceivable that the fixing unit and the inner housing are designed at least partially as a single piece, in particular as a single part. In particular, the fixing unit is arranged at least partially, and advantageously completely, between the inner housing and the outer housing of the housing unit.

It is also proposed that the transceiver interface has a power transmission unit for the inductive supply of power for at least one external mobile device, in particular for the aforementioned external mobile device. This allows the design as well as user convenience to be further increased, since at least one external mobile device can be inductively charged by means of a transceiver interface. The charging process can also be simplified and made more efficient, with only the external mobile device needing to be brought into contact with the housing unit. Separate connections and plug connections can thus be explicitly dispensed with and thus wear of plug contacts due to plugging and unplugging them can be prevented. In addition, the built-in power transmission unit can allow a wide range of external mobile devices to be charged.

In particular, the power transmission unit has at least one main functionality in the form of wireless power transmission, in particular in a wireless power supply of external mobile devices. In at least one operating state, the power transmission unit can provide inductive energy, for example, for a charging operation of the external mobile device. For the provision of power, the power transmission unit has at least one supply induction element, which has in particular at least one coil, for example a copper coil, in particular at least one primary coil, and/or is designed as a coil and which provides inductive energy in the operating state. In particular, the inductive power transmission, namely the inductive charging process, is based on the generally known Qi-Charging standard, Qi being a standard of the Wireless Power Consortium (WPC) for wireless power transmission by means of electromagnetic induction over short distances. If the external mobile device is arranged on the housing unit, the power supply unit can transfer inductive energy to the external mobile device in the operating state, in particular to charge the external mobile device.

The power transmission unit could comprise at least two or more supply induction elements, which in the operating state could provide power inductively in each case, in particular to a single receiving induction element or to at least two or more receiving induction elements of the external mobile device. At least some of the supply induction elements could be arranged in close range of each other, for example in a row, in the form of a circle or in the form of a matrix. Particularly preferably, the power transmission unit has exactly one supply induction element, in particular exactly one coil, which is arranged in a circular configuration. The fixing unit, in particular the magnetic elements, could be arranged at least partially outside the power transmission unit, in particular outside the circular coil. Advantageously, the fixing unit, in particular the magnetic elements, are arranged next to the power transmission unit, in particular next to the supply induction element, and at least in some sections along an outer circumference of the supply induction element. Alternatively and/or additionally, the fixing unit and the power transmission unit can be arranged at least partially overlapping, in particular along the outer circumference of the supply induction element. The fixing unit may be located immediately adjacent to the supply induction element and contact the supply induction element, at least in some sections or completely. The power transmission unit may be located on the inner housing of the housing unit and/or be connected to the inner housing. It would also be conceivable for the power transmission unit and the inner housing to be designed at least partially as a single piece, in particular as a single part. In particular, the power transmission unit is arranged at least partially, and advantageously completely, between the inner housing and the outer housing of the housing unit.

In a further aspect of the invention, which can be considered in particular as both stand-alone and in combination with the other aspects of the invention, it is proposed that the transceiver interface comprises a connection unit for providing a mobile and/or Internet connection. Such a design can increase efficiency and flexibility. In particular, a mobile and/or Internet connection can be provided independently of an external, Internet-and/pr mobile radio-enabled unit. Again, this can improve both the design and user convenience.

The connection unit may be part of the already mentioned communication interface of the transceiver interface, or at least partially form it. Preferably, the connection unit has at least one eSIM chip. Alternatively or additionally, the connection unit can comprise a SIM card, in particular a micro-SIM or nano-SIM, namely any other type of chip card. The connection unit may be located in and/or on the housing unit and/or the printed circuit board. Preferably, the connection unit is designed to provide a mobile and/or Internet connection for configuring the transceiver, preferably independently of an external, Internet-and/or mobile-radio capable unit, in particular independently of the external mobile device.

Furthermore, the transceiver interface may comprise a power supply unit for the autonomous supply of power to at least the configuration unit, the communication interface and/or the connection unit. In particular, the power supply unit is designed for enabling the configuration of the transceiver by means of the configuration unit in at least the operating state, and preferably independently of an external power supply source, for example, the external unit. In addition, with regard to the design and functioning of the aforementioned power supply unit, reference is also made to the German patent applications DE 10 2021 119 318 A1 and DE 10 2021 119 316 A1 already mentioned, the content of which is incorporated into this application.

The housing unit could have a round, oval or angular, for example triangular or rectangular, shape in a plan view of a main extension plane of the housing unit. It is further proposed that the housing unit has an at least substantially pentagonal outer contour in a plan view of a main extension plane of the housing unit, in particular the above-mentioned main extension plane. This enables a particularly easy-to-handle and compact transceiver interface to be provided and its design to be further improved.

The housing unit may have a transverse extension and/or longitudinal extension of at least 5 cm, advantageously of at least 8 cm, preferably of at least 10 cm and particularly preferably of at least 12 cm, and in particular of at most 20 cm, particularly advantageously of at most 15 cm. In this context, a “longitudinal extension” of an object is to be understood as an extension of the object in a longitudinal extension direction of the object. The “longitudinal extension direction” of the object is a direction which is oriented and/or extends parallel to a longest edge and/or side of an, in particular imaginary, smallest cuboid that just encloses the object. In this context, a “transverse extension” of an object is to be understood as an extension of the object in a transverse extension direction of the object. The “transverse extension direction” of the object is a direction parallel to a second-longest edge and/or side of an in particular the said, smallest, in particular imaginary, cuboid that just encloses the object. Also, the housing unit can have a height extension of at least 3 cm, advantageously at least 5 cm, and preferably a maximum of 15 cm and particularly preferably a maximum of 10 cm.

The outer contour of the housing unit can be honeycomb shaped. In particular, the outer contour of the housing unit has a honeycomb shape. Advantageously, the housing unit has an at least hexagonal outer contour. In particular, the outer contour of the housing unit is at least hexagonal. The outer contour can form an outer edge region of the housing unit in a plan view of the main extension plane of the housing unit. The “main extension plane” of an object shall be understood in the present case as a plane which is oriented parallel to a largest side face of a smallest imaginary cuboid that just completely encloses the object, and in particular passes through the centre of the cuboid. In addition, “at least substantially” in this context shall be understood to mean that a deviation from a predetermined value and/or orientation and/or shape is less than 25%, preferably less than 10%, and particularly preferably less than 5% of the predetermined value and/or orientation and/or shape.

The housing unit, in particular the outer housing and/or the inner housing, can be formed at least partially and/or to a large extent or completely from a mineral, a plastic a metal and/or a composite material. The term “to a large extent” shall be understood to mean in the present case at least 55%, advantageously at least 65%, preferably at least 75%, particularly preferably at least 85% and particularly advantageously not more than 95% of a surface area and/or volume and/or mass proportion. It would be conceivable for the housing unit to be at least partially formed of a translucent or transparent material. The housing unit could be at least partially formed of a diffuse material, which is designed to scatter light and/or reduce a light intensity.

The housing unit, in particular the outer housing and/or the inner housing, may be at least partially or completely designed as a single piece, in particular a single part. The term “single piece” should be understood to mean connected in a materially bonded manner, for example by means of an adhesive process, an injection moulding process and/or welding process and/or any other process that a person skilled in the art considers reasonable. “Single-part” is understood to mean shaped in one piece. Preferably, this is a piece produced from a single blank, a compound and/or casting, particularly preferably from the single blank in an injection moulding process, in particular a single-and/or multi-component injection moulding process, and/or in a stamping process and/or in a sheet-metal bending process and/or in a printing process, for example a 3D printing process, and/or by thermoforming and/or by any other process which the person skilled in the art considers reasonable.

For communication with the user, the transceiver interface can have at least one acoustic output unit. The transceiver interface could use acoustic signals to transmit and/or communicate at least one operating state, in particular information regarding the operating state, to the user. Preferably, the transceiver interface has at least one optical output unit.

It is additionally proposed that the transceiver interface has a display unit for displaying at least an operating status and/or an operating mode, which follows an outer contour of the housing unit, at least in sections. This can increase convenience with regard to user-friendliness. In addition, a high flexibility and/or handling ability of a transceiver interface can be provided, because the display unit can display different operating statuses, operating states and/or operating modes of the transceiver interface. This allows the design and efficiency to be further optimized.

In particular, the optical output unit comprises the display unit. The display unit may be designed to display at least the operating status and/or the operating mode in at least the operating state. It would be conceivable that the display unit comprises at least one light source, for example a light-emitting diode (LED), an organic light-emitting diode (OLED) and/or electronic paper (e-paper, ePaper) or the like. Preferably, the display unit, in particular the light source, provides an RGB colour system. The display unit could potentially display the operating status and/or operating mode using different colours. For example, in a first operating status and/or first operating mode, the display unit might emit yellow light and/or in a second operating status and/or second operating mode, green light and/or in a third operating status and/or third operating mode, blue light. In addition, the display unit may flash and/or remain continuously lit in the operating state to indicate the operating status and/or operating mode.

The first operating status and/or first operating mode could be, for example, a status and/or mode in which the transceiver interface searches for a communication link to the external unit and/or attempts to establish the same. The display unit could flash when the transceiver interface is not connected to the external unit. If the communication link exists, in particular the wireless communication link and/or the wire-bound communication link, between the transceiver interface and the external unit, the display unit could indicate this operating status and/or the operating mode, in particular second operating status and/or second operating mode, by means of a permanently illuminated display, in particular a permanent illumination of at least the light source. For example, the second operating status and/or second operating mode may be a state in which the transceiver interface is connected to the external unit.

Preferably, the display unit has an illuminated ring or is formed as such. The illuminated ring can be arranged in the circumferential direction along the outer contour of the housing unit. The display unit may be designed to illuminate at least one surrounding area of the housing unit. Advantageously, the display unit illuminates a resting surface, for example of a table and/or a hand and/or the like, on which the housing unit can be positioned in an arranged, preferably resting state. The display unit could illuminate the resting surface at an angle of at least 30°, advantageously at least 40° and preferably at least 45°, and/or emit and/or radiate and/or output light. In the operating state, the power supply unit can autonomously supply at least the display unit with power.

It is additionally proposed that the transceiver interface has a user interface for interaction with at least one user. This provides a particularly user-friendly and convenient design and further improves the handling capability for a user. In addition, security can be increased and identification of a user can be carried out, in particular to prevent the use by disallowed and/or unauthorized users.

The user interface can have at least one operating unit. An “operating unit” shall be understood here to mean a unit which has at least one operating element which can be operated directly by and/or from the user, and which is designed, by means of actuation and/or by the input of parameters, to influence and/or modify a process and/or a state of a unit coupled to the operating unit, in particular of the configuration unit and/or at least one other unit of the transceiver interface, such as the power transmission unit, the communication unit, the connection unit or the like. Preferably, the operating unit is designed at least for switching the transceiver interface on and off and/or for coupling and/or connecting the transceiver interface to at least the external unit, in particular the external mobile device. The operating unit can be a push-button that can be pressed by the user. Alternatively, the operating unit may also be configured as a switch, for example a toggle switch, and/or a touch display or the like.

Preferably, the user interface has an identification unit for identifying the user. The identification unit can identify the user at least haptically and/or optically. Advantageously, the identification unit has at least one sensor element, which is formed as a capacitive and/or touch-sensitive sensor and can be designed to identify the user based on haptic feedback, for example by means of a fingerprint. Alternatively or additionally, the identification unit may comprise at least one optical sensor element, such as a camera, which is designed to identify the user by means of face and/or iris recognition and/or by means of characteristic gestures. It would also be conceivable that, by means of the user's gestures, commands and/or information for controlling the transceiver interface can be transmitted and at least recognized and in particular processed by the identification unit. The user could use gesticulation to control at least the configuration unit and/or any other unit of the transceiver interface, such as the power transmission unit, the communication unit, the connection unit or the like, and/or to at least affect and/or modify an operating state of the transceiver interface.

The transceiver interface and/or the transceiver system shall not be restricted to the application and embodiment described above. In particular, in order to fulfil a function described herein the transceiver interface and/or the transceiver system may have a number of individual elements, components and units that differs from a number specified herein. In addition, with regard to the ranges of values specified in this document, values within the aforementioned bounds should also be regarded as disclosed and as usable as desired.

### DRAWINGS

Further advantages are obtained from the following description of the drawings. The drawings illustrate an exemplary embodiment of the invention. The drawings, the description and the claims contain numerous features in combination. The person skilled in the art will also advantageously consider the features individually and combine them to form further meaningful combinations.

Shown are:

FIG. 1 a transceiver system having a transceiver interface and a transceiver in an uninserted state,

FIG. 2 a detailed view of the transceiver interface, which has a housing unit,

FIG. 3 a side view of the transceiver interface according to FIG. 2,

FIG. 4 a rear view of the transceiver interface according to FIG. 2,

FIG. 5 an internal view of the transceiver interface onto an inner housing and a part of an outer housing of the housing unit, wherein the transceiver is plugged into a transceiver slot of the transceiver interface,

FIG. 6 a further internal view of the transceiver interface, wherein a further transceiver is inserted into a further transceiver slot of the transceiver interface,

FIG. 7 an internal view of the transceiver interface in a plan view with the transceiver plugged into the transceiver slot and

FIG. 8 the transceiver system with an external unit, which is positioned on the transceiver interface and fixed to the housing unit by means of a fixing unit of the transceiver interface.

### DESCRIPTION OF THE EXEMPLARY EMBODIMENT

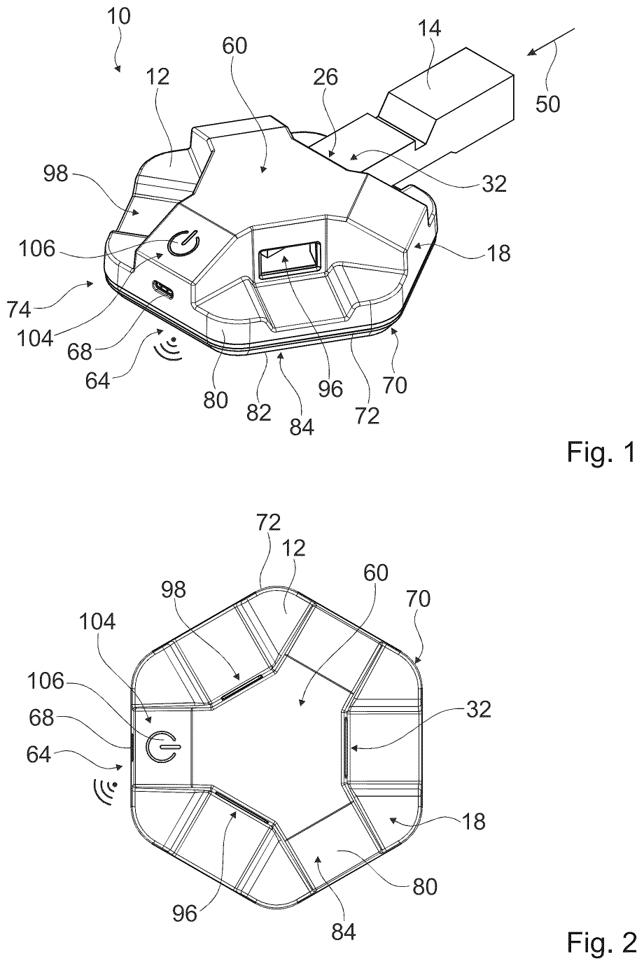

FIG. 1 shows a transceiver system 10 with a transceiver interface 12. The transceiver system 10 is implemented as an optical transceiver system and is designed to configure and/or reconfigure at least one transceiver 14. The transceiver system 10 in this case is an SFP-DD, OSFP und QSFP-DD transceiver system. Alternatively and/or additionally, the transceiver system 10 could be a CFP, an XFP, SFP and/or a QSFP transceiver system. The transceiver system 10 comprises at least the transceiver 14. The transceiver 14 is a pluggable transceiver. The transceiver 14 could be a CFP, an XFP, an SFP-, SFP-DD, a QSFP, a QSFP-DD, an NGSFP, NGSFP-DD, an OSFP or a QSFP-XD transceiver. In the present exemplary embodiment, the transceiver 14 is implemented as an OSFP transceiver. The transceiver interface 12 is designed for configuration and/or reconfiguration of at least the transceiver 14. In the present case, the transceiver interface 12 is designed to be mobile and/or portable, namely as a portable transceiver interface 12. In addition, FIG. 8 also shows the transceiver system 10. The transceiver system 10 has an external unit, which in the present case is designed as a mobile device 62. The mobile device 62 is arranged on the transceiver interface 12.

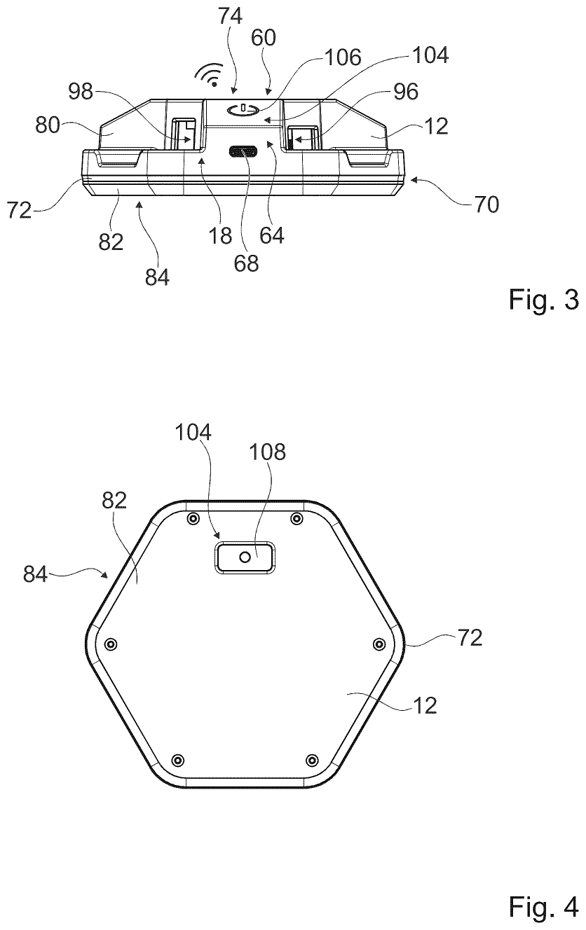

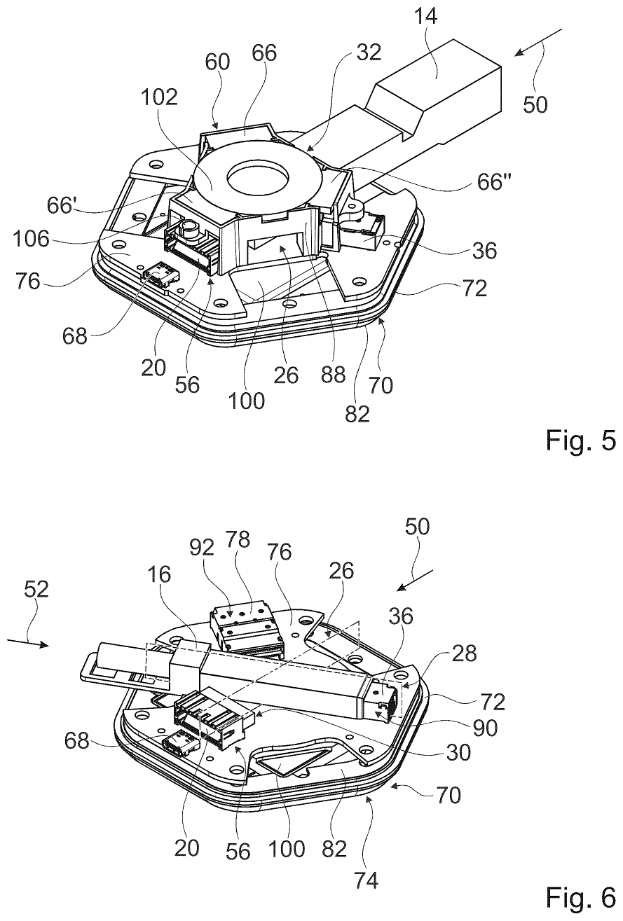

The transceiver interface 12 has a housing unit 18. The housing unit 18 in the present case has an outer housing 84 and an inner housing 88. In FIGS. 1 to 4, closed views of the housing unit 18 of the transceiver interface 12 are shown in each case, while FIG. 5 to 7 show an open state of the housing unit 18. In FIG. 5, the housing unit 18 is opened in such a way that the inner housing 88 is shown.

At least FIGS. 1 to 4 illustrate that the housing unit 18 in a plan view of a main extension plane of the housing unit 18 has an at least substantially, at least pentagonal outer contour 70. In this exemplary embodiment, the outer contour 70 of the housing unit 18 has an at least hexagonal shape. The outer contour 70 of the housing unit 18 is at least hexagonal. The outer contour 70 in the present case is honeycomb shaped. Alternatively, the outer contour 70 of the housing unit 18 can also be round or oval.

For connecting the pluggable transceiver 14, the transceiver interface 12 has at least one transceiver slot 20. In this case, the transceiver slot 20 is provided for connecting the OSFP transceiver 14. The transceiver 14 can be inserted into the transceiver slot 20 along a plug-in direction 50. FIGS. 1, 5, 7 and 8 illustrate the arrangement of the transceiver 14 in the transceiver slot 20 in an inserted state. The housing unit 18 in this case has a receiving space 26 for receiving at least a major part of the transceiver 14 in the transceiver slot 20 in the plugged-in state of the transceiver 14. In particular, the housing unit 18 is designed for mounting and/or holding at least a major part of the transceiver 14 in the plugged-in state. In the present case, the receiving space 26 in the plugged-in state of the transceiver 14 receives at least 50% of a longitudinal extension of the transceiver 14. In addition, the housing unit 18 is designed to accommodate at least a major part of the weight of the transceiver 14 in the plugged-in state. This can avoid and/or prevent fracturing and/or bending of the transceiver 14 and an insecure and/or unstable connection of the transceiver 14 to the transceiver slot 20.

The transceiver interface 12 has a printed circuit board 76. At least the transceiver slot 20 is arranged on the printed circuit board 76. The printed circuit board 76 is arranged in the housing unit 18 and at least partially enclosed by the housing unit 18. In the present case, the housing unit 18, namely the outer housing 84, has a first outer housing element 80 and at least a second outer housing element 82. The first outer housing element 80 is designed as a housing cover (cf. FIGS. 1 to 4). The second outer housing element 82 in the present case is designed as a housing bottom (cf. FIGS. 1 to 8). The printed circuit board 76 is connected at least to the second outer housing element 82 and arranged thereon. The inner housing 88 is arranged between the first outer housing element 80 and the second outer housing element 82. The receiving space 26 extends at least in some sections within the inner housing 88. FIG. 5 shows a view of the inner housing 88, which is arranged above the second outer housing element 82. The inner housing 88 is arranged in this case above and/or on the printed circuit board 76. The inner housing 88 encloses and/or surrounds the transceiver slot 20 at least in some sections. An insertion opening 30 of the transceiver slot 20 is facing the receiving space 26. The insertion opening 30 is surrounded by the inner housing 88 and/or bounded by the inner housing 88 on at least three sides. Thus, a high level of protection of the insertion opening 30 of the transceiver slot 20 can be ensured against, for example, environmental influences.

The housing unit 18 has at least one feed-through opening 32 for feeding the transceiver 14 through to the transceiver slot 20 (cf. FIGS. 1, 2 and 5). The feed-through opening 32 is arranged at an opposite end of the housing unit 18 to the insertion opening 30 of the transceiver slot 20. The receiving space 26 extends at least between the feed-through opening 32 and the insertion opening 30 of the transceiver slot 20. In the present case, the receiving space 26 additionally extends, at least in some sections, outside the feed-through opening 32 and is bounded by at least the second outer housing element 82. The inner housing 88 and at least the outer housing 84 together form the feed-through opening 32 in the present case. The inner housing 88 and at least the outer housing 84 bound the feed-through opening 32 at least on one side. In this exemplary embodiment, the transceiver interface 12 has further feed-through openings 96, 98, namely in the present case a total of at least three feed-through openings 32, 96, 98.

The transceiver interface 12 in this exemplary embodiment is designed to receive at least one further transceiver 16. To this end, the transceiver interface 12 has at least one further transceiver slot 36. The further transceiver 16 may be a transceiver designed identically to the transceiver 14 or belong to the same category of transceiver. In this exemplary embodiment the further transceiver 16 is a QSFP-DD transceiver. Alternatively, the further transceiver 16 could also be designed as a CFP, XFP, an SFP, SFP-DD, a QSFP, a QSFP-DD, an OSFP, an OSFP-XD, an NGSFP or an NGSFP-DD transceiver. The further transceiver 16 is designed for connection to the further transceiver slot 36. The further transceiver 50 can be plugged into the further transceiver slot 36 along an additional insertion direction 52 (cf. FIG. 6). In a plugged-in state, the further transceiver 16 is arranged in an further receiving space 28 of the housing unit 18. The descriptions already given for the receiving space 26 are also transferable to the further receiving space 28, taking into account the reference to the further transceiver slot 36. In addition, the descriptions regarding an arrangement of the transceiver slot 20 can also be transferred to the further transceiver slot 36. The further transceiver 16 can be fed through the additional feed-through opening 98 for connection to the further transceiver slot 36.

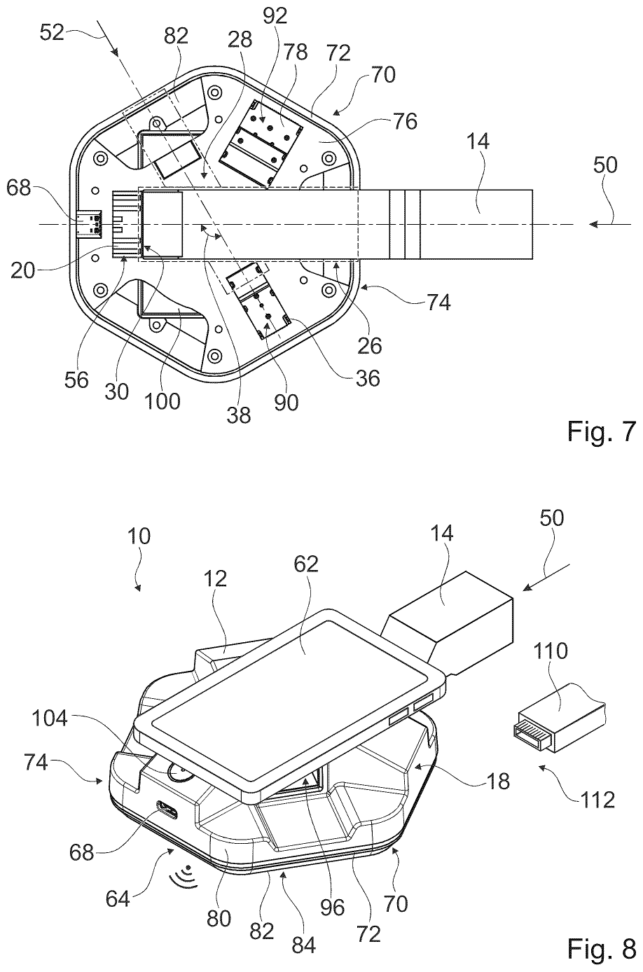

In the present case, the receiving space 26 intersects with the further receiving space 28 in at least some sections. FIG. 6 illustrates that in the plugged-in state of the further transceiver 16, the connection of the transceiver 14 to the transceiver slot 20 is blocked. Furthermore, FIG. 7 illustrates that in the plugged-in state of the transceiver 14 in the transceiver slot 20, the connection of the further transceiver 16 to the further transceiver slot 36 is blocked. In the present case, the plug-in direction 50 of the transceiver slot 20 and the additional plug-in direction 52 of the further transceiver slot 36 enclose an angle 38 of at least 100° (cf. FIG. 7). In this exemplary embodiment, the angle 38 encloses 120°.

The transceiver interface 12 has an additional further transceiver slot 78 (cf. FIGS. 6 and 7). The transceiver interface 12 also comprises at least three transceiver slots 20, 36, 78 in total. The additional further transceiver slot 78 is designed for connecting an additional further transceiver (not shown). The descriptions regarding an arrangement of the transceiver slot 20 are also transferable to the additional further transceiver slot 78. The additional further transceiver can be fed through the additional further feed-through opening 96 for connection to the additional further transceiver slot 78.

For sensing at least one temperature characteristic of at least the transceiver 14 in the plugged-in state, the transceiver interface 12 has at least one sensor unit 56. The sensor unit 56 in this case is arranged on the transceiver slot 20. Alternatively and/or additionally, the sensor unit 56 could be arranged on the printed circuit board 76 and/or the housing unit 18. If the transceiver 14 is plugged into the transceiver slot 20, the sensor unit 56 senses and/or detects the temperature characteristic. Based on the sensed and/or detected temperature characteristic, an existing temperature, namely an actual temperature, can be determined during operation of the transceiver interface 12. The transceiver interface 12 has at least one further sensor unit 90 for sensing at least one further temperature characteristic of at least the further transceiver 16 in the plugged-in state. The additional sensor unit 90 in this case is arranged on the further transceiver slot 36. Alternatively and/or additionally, the additional sensor unit 90 could be arranged on the printed circuit board 76 and/or the housing unit 18. If the further transceiver 16 is plugged into the further transceiver slot 36, the additional sensor unit 90 senses and/or detects the additional temperature characteristic. Furthermore, the transceiver interface 12 has at least one additional further sensor unit 92 for sensing at least one additional further temperature characteristic of at least the additional further transceiver in a plugged-in state. The additional further sensor unit 92 in this case is arranged on the additional further transceiver slot 78. Alternatively and/or additionally, the additional further sensor unit 92 could be arranged on the printed circuit board 76 and/or the housing unit 18. If the additional further transceiver is plugged into the additional further transceiver slot 78, the additional further sensor unit 92 senses and/or detects the additional further temperature characteristic.

The transceiver interface 12 has a fixing unit 60 for the force-fitting and/or positive-locking fixation of the external mobile device 62 to the housing unit 18. In order to provide a particularly flexible, easy-to-handle and comfortable design, the fixing unit 60 has at least one magnetic element 66 for providing a magnetic fixation (cf. FIG. 5). The magnetic element 66 is designed to interact with a counter-magnetic element of the external mobile device 62. The fixing unit 60 could comprise exactly one magnetic element 66, which has, for example, a round or oval shape. In this exemplary embodiment, the fixing unit 60 comprises at least three magnetic elements 66, 66′, 66″ in total, which interact to jointly provide the magnetic fixation. The three magnetic elements 66, 66′, 66″ have an angular shape and are arranged opposite one another, in this case in the shape of a triangle (cf. FIG. 5). The fixation shown in FIG. 7 between the external mobile device 62 and the transceiver interface 12 exists due to the magnetic connection. In the present case, the fixing unit 60 is designed for a reversible, in fact releasable, connection of the external mobile device 62 to the housing unit 18. The fixing unit 60, in the present case specifically the magnetic elements 66, 66′, 66″, are arranged on the inner housing 88 of the housing unit 18 and connected to the same. The fixing unit 60 is advantageously arranged completely between the inner housing 88 and the outer housing 84 of the housing unit 18.

Furthermore, the transceiver interface 12 has a power transmission unit 102 for inductively supplying power for at least the external mobile device 62 (cf. FIG. 5). The power transmission unit 102 has at least one main functionality in the form of a wireless power transmission and provides inductive energy in at least one operating state, namely at least for a charging operation of the external mobile device 62. To supply power, the power transmission unit 102 has at least one supply induction element, which in the present case is designed in the form of a coil, namely a copper coil. In this exemplary embodiment, the power transmission unit 102 has exactly one supply induction element, which is arranged in a circular shape. FIG. 5 illustrates that the fixing unit 60, namely the magnetic elements 66, 66′, 66″ are arranged at least partially overlapping with the power transmission unit 102, at least in some sections along an outer circumference of the power transmission unit 102. The power transmission unit 102 is arranged on the inner housing 88 of the housing unit 18 and connected to the inner housing 88. The power transmission unit 102 in the present case is advantageously arranged completely between the inner housing 88 and the outer housing 84 of the housing unit 18. The present inductive energy transmission, namely the inductive charging process of the external mobile device 62, is based on the generally known Qi-Charging standard. If the external mobile device 62 is arranged on the housing unit 18, the power supply unit 102 transmits inductive energy to the external mobile device 62 in the operating state, and thus charges the external mobile device 62 (cf. FIG. 7).

The transceiver interface 12 communicates with the mobile device 62 by means of a communication interface. Communication between the transceiver interface 12 is wireless and/or wired. In the present case, the transceiver interface 12 has a wireless communication unit 64 for wireless communication with the mobile device 62. By means of the wireless communication unit 64, at least a wireless data transmission to the mobile device 62 is provided. Furthermore, the transceiver interface 12 has at least one wire-bound communication unit 68. In this exemplary embodiment, the wire-bound communication unit 68 is configured as a USB-C port. The wire-bound communication unit 68 is designed for communication, namely for data transmission and/or for supplying power to the external mobile device 62. In addition, the wire-bound communication unit 68 in the present case is designed for supplying power to the transceiver interface 12 and/or for the purposes of charging an energy storage unit of the transceiver interface 12 (not shown).

The transceiver interface 12 has a connection unit 74 for providing a mobile and/or Internet connection. The connection unit 74 is designed to provide a mobile and/or Internet connection for configuring the transceiver 14 and/or at least the further transceiver 16, independently of an external, Internet-and/or mobile-radio capable unit, such as the external mobile device 62. In this exemplary embodiment, the connection unit 74 has at least one eSIM chip. Alternatively and/or additionally, the connection unit 74 could also have a SIM card. Preferably, the transceiver interface 12 has at least one storage unit 100 for storing at least operating parameters and/or configuration settings.

For communication and interaction with a user, the transceiver interface 12 has at least one user interface 104. The user interface 104 has at least one operating unit 108. The operating unit 108 in this case is a push-button. Alternatively, the operating unit 108 may also be configured as a switch, for example as a toggle switch, and/or a touch display or the like. The operating unit 108 is designed at least for switching the transceiver interface 12 on and off and/or for coupling and/or connecting it to at least the external mobile device 62. In this exemplary embodiment, the operating unit 108 is arranged on a bottom of the housing unit 18. The operating unit 108 is integrated into the second outer housing element 82 (cf. FIG. 4).

To identify the user in order to prevent use by disallowed and/or unauthorized users, the transceiver interface 12 has an identification unit 106. The identification unit 106 identifies the user haptically and/or optically. The identification unit 106 has at least one sensor element. The sensor element in the present case is designed at least as a touch-sensitive sensor, which is designed to identify the user by means of a fingerprint. Alternatively or additionally, the identification unit 106 may comprise at least one optical sensor element, such as a camera, which is designed to identify the user by means of face and/or iris recognition and/or by means of characteristic gestures. Also, by means of the user's gestures, commands and/or information for controlling the transceiver interface 12 could be transmitted and at least recognized by the identification unit 106. The user can affect and/or modify at least one operating state of the transceiver interface 12 by means of gesticulation. The identification unit 106 in this exemplary embodiment is arranged on an upper side of the transceiver interface 12. The identification unit 106 is at least partially integrated into the first outer housing element 80.

For displaying at least one operating status and/or operating mode, the transceiver interface 12 has a display unit 72. It would be conceivable that the transceiver interface 12 additionally has an acoustic output unit (not shown here). The display unit 72 in this exemplary embodiment follows, at least in some sections, the outer contour 70 of the housing unit 18. The display unit 72 is formed as an illuminated ring and arranged in the circumferential direction along the outer contour 70 of the housing unit 18. The display unit 72 is designed to display the operating status and/or the operating mode using different colours. Furthermore, the display unit 72 is designed at least to flash and/or be continuously illuminated in one operating state, to display the operating status and/or the operating mode or information regarding the operating status and/or the operating mode.

In order to provide a particularly flexible, efficient and convenient transceiver system 10 which has a high versatility of connection options, the transceiver system 10 has at least one serial interface 112 for providing a serial connection between the transceiver interface 12 and a data transmission unit (not shown). For example, the serial interface 112 can be an RJ45 or an RS232 interface. For example, the data transmission unit can be an RJ45 connector, an RS232 connector, or an Ethernet connector, or another type of telephone and/or Internet connector.

According to FIG. 8 it is clear that the transceiver system 10 comprises an adapter 110 for connecting to the transceiver interface 12 and for providing the serial connection between the transceiver interface 12 and the data transmission unit. The adapter 110 is an accessory and/or retrofit part of the transceiver system 10 for the transceiver interface 12. The adapter 110 is mobile, in particular portable. In particular, the adapter 110 is provided for communication with at least the transceiver interface 12. The adapter 110 can be reversibly plugged into at least the transceiver slot 20, the further transceiver slot 36 or at least the additional further transceiver slot 78. In this exemplary embodiment, the adapter 110 is designed to provide a serial connection from an SFP transceiver slot to an RJ-45 port, which allows network switches to be configured. Alternatively, the transceiver interface 12 itself may comprise the serial interface in the form of a slot, such as an RJ-45 slot. It is thus possible to dispense with an additional adapter 110.

### List of Reference Signs

10 transceiver system
12 transceiver interface
14 transceiver
16 transceiver
18 housing unit
20 transceiver slot
26 receiving space
28 receiving space
30 insertion opening
32 feed-through opening
36 transceiver slot
38 angle
50 direction of insertion
52 direction of insertion
56 sensor unit
60 fixing unit
62 mobile device
64 wireless communication unit
66 magnetic element
68 wire-bound communication unit
70 external contour
72 display unit
74 connection unit
76 printed circuit board
78 transceiver slot
80 external housing element
82 external housing element
84 outer housing
88 inner housing
90 sensor unit
92 sensor unit
96 feed-through opening
98 feed-through opening
100 storage unit
102 power transmission unit
104 user interface
106 identification unit
108 operating unit
110 adapter
112 serial interface

1. A mobile transceiver interface, comprising:
at least one transceiver slot designed for connecting a pluggable transceiver,
at least one further transceiver slot designed for connecting an further transceiver and having a housing unit that has a receiving space for receiving at least a major part of the transceiver in a plugged-in state of the transceiver in the transceiver slot, wherein the housing unit has at least one further receiving space for receiving at least a major part of a further transceiver, which at least partially intersects with the receiving space, whereby the further transceiver slot is blocked in a plugged-in state of the transceiver in the transceiver slot, for connecting the additional transceiver. cm 2. The transceiver interface according to claim 1, wherein an insertion opening of the transceiver slot faces the receiving space.

3. The transceiver interface according to claim 2, wherein the housing unit has at least one feed-through opening for feeding the transceiver through to the transceiver slot, which opening is arranged at an opposite end of the housing unit to the insertion opening of the transceiver slot.

4. (canceled)

5. The transceiver interface according to claim 1, wherein an insertion direction of the transceiver slot and a further insertion direction of the further transceiver slot enclose an angle of at least 100°.

6. The transceiver interface according to claim 1, further comprising at least one sensor unit for sensing at least one temperature characteristic of at least the transceiver in a plugged-in state.

7. The transceiver interface according to claim 1, further comprising fixing unit for the force-fitting and/or positive-locking fixing of an external mobile device to the housing unit.

8. The transceiver interface according to claim 7, wherein the fixing unit includes at least one magnetic element for providing a magnetic fixation.

9. The transceiver interface according to claim 1, further comprising a power transmission unit for the inductive provision of power for at least one external mobile device.

10. The transceiver interface according to claim 1, further comprising a connecting unit for providing a mobile and/or Internet connection.

11. The transceiver interface according to claim 1, wherein the housing unit, in a plan view of a main extension plane of the housing unit, has an at least substantially, at least pentagonal outer contour.

12. The transceiver interface according to claim 1, further comprising a display unit for displaying at least an operating status and/or operating mode, which follows an outer contour of the housing unit, at least in sections.

13. The transceiver interface according to claim 1, further comprising at least one user interface for interaction with a user.

14. A transceiver system comprising a transceiver interface according to claim 1 and comprising at least the transceiver.

15. The tranaceiver system according to claim 14, further comprising at least one serial interface for providing a serial connection between the transceiver interface and a data transmission unit.
